(19) United States
(12) Patent Application Publication
(10) Pub. No.: US 2023/0335773 A1
(43) Pub. Date: Oct. 19, 2023

(54) FUEL CELL ASSEMBLY AND METHOD FOR PRODUCING A FUEL CELL ASSEMBLY

(71) Applicant: Vitesco Technologies GmbH, Regensburg (DE)

(72) Inventors: Markus Ochs, München (DE); Stefan Granzow, München (DE)

(21) Appl. No.: 18/026,895

(22) PCT Filed: Sep. 24, 2021
(86) PCT No.: PCT/EP2021/076330

§ 371 Date: Mar. 17, 2023

(30) Foreign Application Priority Data
Sep. 25, 2020 (DE) 10 2020 212 104.4

(51) Int. Cl. H01M 8/248; H01M 8/0202; H01M 8/1004

(52) U.S. Cl. CPC H01M 8/248; H01M 8/0202; H01M 8/1004; H01M 2008/1095

(57) ABSTRACT

A fuel cell stack, having fuel cells stacked in a stacking direction, each of which has a plate-shaped form extending in a first and second transverse directions, as viewed orthogonally in relation to the stacking direction. The fuel cells have a stack of: an anode-side bipolar half-plate with a fuel channel structure for conducting fuel; an anode-side gas diffusion layer; a membrane-electrode unit, having electrolyte membrane and electrode layers arranged on either side of the electrolyte membrane forming an anode and cathode for electrochemical reaction of the fuel with an oxidizing agent; a cathode-side gas diffusion layer; a cathode-side bipolar half-plate with an oxidizing agent channel structure for conducting the oxidizing agent; and end plates at either end of the stack in the stacking direction. On the side of the stack, belt receptacles are mounted on the end plates, and belts are mounted over the belt receptacles clamping the stack.

### CROSS REFERENCE TO RELATED APPLICATIONS

This application is the U.S. National Phase Application of PCT International Application No. PCT/EP2021/076330, filed Sep. 24, 2021, which claims priority to German Patent Application No. 10 2020 212 104.4, filed Sep. 25, 2020, the contents of such applications being incorporated by reference herein.

### FIELD OF THE INVENTION

The present invention relates to clamping possibilities in order both to be able to ensure fast manufacture and clamping of a stack and to set the required clamping force, and to enable the necessary flexibility or expansion rate of a fuel cell arrangement.

### BACKGROUND OF THE INVENTION

In the prior art, a fuel cell arrangement is often referred to as fuel cell stack or “stack” and has fuel cells stacked in a stacking direction, each of which has a plate-shaped form and extends in a first transverse direction and a second transverse direction, orthogonal to the first, as viewed orthogonally in relation to the stacking direction.

In the stacking direction, fuel cells have a stack of the following:
an anode-side bipolar half-plate with a fuel channel structure for conducting a fuel,
an anode-side gas diffusion layer,
a membrane-electrode unit, having an electrolyte membrane and electrode layers which are arranged on either side of said electrolyte membrane in the stacking direction and form an anode and a cathode for an electrochemical reaction of the fuel with an oxidizing agent,
a cathode-side gas diffusion layer,
a cathode-side bipolar half-plate with an oxidizing agent channel structure for conducting the oxidizing agent.

As regards the prior art for fuel cell stacks of this type, reference is made by way of example to the publications EP 2 357 698 B1, EP 2 445 045 B1, EP 2 584 635 B1, EP 2 946 431 B1 and EP 3 316 377 A1, each incorporated herein by reference.

Fuel cell stacks are typically mechanically clamped by means of clamping bolts or screws and spring elements. In addition, there are solutions which guide a (usually metallic) band around the stack, the band then being secured to securing points on the end plates of the stack and pretensioned; in this respect, see e.g. US 2006/093890 (Steinbroner), incorporated herein by reference. An additional solution is clamping means based on toothed belts or V-belts and based on multiple belts together with multiple clamping units.

A weakness for the clamping of the stacks is the multiplicity of clamping points, or screws and movable components, that are required to set the preload force together with spring elements or possibly clamping bands. For mass production and incorporation in a fast and productive manufacturing installation, fast clamping processes are necessary. In addition, the number of individual parts required for manufacture and for clamping must be kept as low as possible.

In order both to be able to ensure fast manufacture and clamping of a stack and to set the required clamping force, and to obtain the necessary flexibility and expansion rate of a clamping band, belt elements are quite suitable.

The central clamping, however, entails decisive drawbacks concerning the deflection rates or change in radius of the belt and the high structure of the end plates. In addition, a central clamping unit does not make it possible to adapt to possibly deviating belt expansion rates or clamping forces.

### SUMMARY OF THE INVENTION

A solution with few belts and a low number of mechanical components, which nevertheless enables adaptation to tolerance deviations without significantly increasing the installation space required for the stack, could be advantageous. Said solution may be achieved by widening the stack housing around and in the belt guide means.

According to an aspect of the invention, what is provided here is that, on the side of the fuel cell stack, belt receptacles are mounted on the end plates, and belts are mounted over the belt receptacles such that they clamp the stack.

A belt receptacle which, on the side of the stack, abuts e.g. the end plates, here meets both the requirement of easy installation and the requirement of space-saving and adaptable introduction of force into the end plates via belts.

The fuel cell stack has a longitudinal axis in the stacking direction and side surfaces which are formed by the side surfaces of the fuel cells and run parallel to the stacking direction and longitudinal axis of the stack. A cuboidal fuel cell stack has, for example, two pairs each of two mutually opposite parallel side surfaces, which face one another orthogonally.

Preferably, at either end the stack has a respective end plate, on which belt receptacles are mounted on two mutually opposite side surfaces, the belt receptacles projecting beyond the side surfaces. The belt receptacles project both beyond the side surfaces of the end plates and beyond the side surfaces of the stack that are formed by the side surfaces of the fuel cells.

According to a preferred refinement, this belt receptacle is variable in terms of height (i.e. along the stacking direction) or installed settably on the end plates. This enables adaptation of the force by means of which the stack is clamped after the installation. The clamping can thus be re-adjusted or set after the installation has finished.

When a belt with a fixed and unchangeable length is installed, a relative displacement of a belt receptacle with respect to the end plate in the stacking direction from the stack center to the stack end presses the end plate toward the stack center to a greater extent. A stronger compressive force is thus exerted on the stack. By contrast, the compressive force can be reduced if the belt receptacle is displaced toward the stack center relatively with respect to the end plate. Displacing and/or fixing the relative position of the belt receptacle with respect to the end plate is possible, for example, by way of an adjusting screw or another mechanical adjustment mechanism. A clamping force can also be exerted by elastic deformation of the clamping belt.

A belt as clamping element could also be pushed over the belt receptacle at the end of the manufacture of the stack, e.g. after initial pretensioning of the stack. This could then be set to the desired pretension. After the clamping process, the stack is finished.

In a particularly advantageous embodiment of the fuel cell stack according to the invention, belt arrangements are arranged on an upper and a lower end plate of the stack such that a continuously intrinsically closed clamping belt can be fitted. The compressive force for clamping the stack can then, as described above, be set by displacement of the belt receptacle in the stacking direction.

Preferably, the intrinsically closed belt in the installed state has an imaginary plane, the perpendicular bisector of which runs orthogonally in relation to a side surface of the stack and to the longitudinal axis of the stack. In this respect, the plane spanned by the belt is preferably parallel to the side surface of the stack. Preferably, the clamping belt is arranged in relation to the side surface such that its perpendicular bisector orthogonally intersects the longitudinal axis of the stack. This geometry allows the clamping belt to be easily fitted onto the stack from the side.

The embodiment can be realized both with two or four and with multiple belt receptacles which can be mounted on the longitudinal or transverse side of the stack.

Preferably, the fuel cell stack has such a clamping belt on at least two mutually opposite side surfaces.

To that end, the end plates of the stack each have a respective belt receptacle on two mutually opposite sides. The belt receptacles advantageously extend over most of the width of the side surface. For example, the belt receptacle extends over at least 50%, at least 60%, or at least 70% of the width of the side surface. The compressive force applied by the belt is thus distributed over the width of the stack. For an even better distribution of force, the belt receptacle can moreover have a circular shape, an ellipsoidal shape, or a semicircular shape. The belt is guided over the belt receptacles and their shape along the width of the side surface of the stack in the transverse direction.

A fitted clamping belt is guided from a first belt receptacle on a first end plate over the width of the belt receptacle, and runs over the length of the stack (in the stacking direction) to a second belt receptacle on a second end plate which is opposite the first in the stacking direction. There, it is guided over the second belt receptacle and guided back to the first belt receptacle. The wide shaping of the belt receptacles causes the clamping belt to extend over most (e.g. more than 50%, more than 60%, or more than 70%) of the side surface of the stack. In a lateral plan view of the side surface of the fuel cell stack, the clamping belt thus borders most (e.g. more than 50%, more than 60%, or more than 70%) of the side surface of the stack (for example annularly, elliptically, or in an oval shape, depending on the shape of the belt receptacles).

It is thus possible to ensure an extensive distribution of force over the stack even with only one clamping belt per side surface of the fuel cell stack. This makes it possible to keep the number of components to be fitted low. A further reduction in the number of components to be fitted can be achieved in that a clamping belt is arranged only on each second side surface of the stack. The above-described geometry of the belt receptacles makes it possible nevertheless to achieve an extensive distribution of force over the stack.

Advantages of the solution according to an aspect of the invention are, inter alia, few individual components that must be assembled to form a fuel cell stack. Correspondingly, fewer tolerances must be considered and handling times can be kept down. An automated clamping device in combination with fast and robust belt clamping and introduction of force into the stack can furthermore be advantageous.

A fuel cell arrangement makes it possible, by way of an electrochemical reaction, to convert the chemical reaction energy of a continuously supplied fuel (e.g. hydrogen) and a continuously supplied oxidizing agent (e.g. oxygen or air) into electrical energy.

During operation of the fuel cells arranged in an electrical series connection by way of the (electrically conductive) bipolar half-plates, the reactants participating in the electrochemical reaction, that is to say the fuel (e.g. hydrogen) and the oxidizing agent (e.g. air), must be supplied on different sides of the membrane-electrode unit inside each fuel cell as viewed in the stacking direction.

To that end, the bipolar half-plates of each fuel cell are each formed with a channel structure on their sides facing toward the membrane-electrode unit, in order to introduce the fuel and the oxidizing agent through these channel structures into the adjacent respective gas diffusion layer on the respective sides of the membrane-electrode unit, and thus to guide them up to the respective electrode layer on the corresponding side of the electrolyte membrane via the respective gas diffusion layer.

The electrode layers are usually made from a carbon material and coated or permeated with a suitable catalyst. In this respect, the fuel-side electrode layer forms an anode and the oxidizing agent-side electrode layer forms a cathode of the membrane-electrode unit.

The product of the electrochemical reaction proceeding in the individual fuel cells, for example water, can be discharged via the fuel cell region that conducts the oxidizing agent (e.g. air).

In the individual fuel cells, the fuel-conducting region, i.e. anode-side channel structure, gas diffusion layer and electrode layer (anode), and the oxidizing agent-conducting region, i.e. cathode-side channel structure, gas diffusion layer and electrode layer (cathode), must be sealed off with respect to one another in order to prevent the exchange of gas between these regions, which is detrimental to the power efficiency.

This implies in particular that at least one of the two regions must be sealed off with respect to the surrounding area of the fuel cell or of the fuel cell stack (e.g. atmosphere), in order to prevent such exchange via the surrounding area. In practice, in this respect at least the fuel-conducting region is sealed off with respect to the surrounding area, in order to prevent loss of fuel from this fuel cell region into the surrounding area and the entry of a medium (e.g. air) into this fuel cell region from the surrounding area.

In particular for the purpose of forming an air-cooled fuel cell arrangement, the oxidizing agent-conducting region can also be configured as “open” toward the surrounding area. For example, the oxidizing agent channel structure provided in the individual fuel cells can be open on two sides of the fuel cell that are opposite one another, as viewed in a transverse direction, in order to enable a flow of the oxidizing agent (e.g. air) through the fuel cell arrangement in this transverse direction during operation. To that end, the oxidizing agent can be driven through the laterally open fuel cell arrangement, e.g. using a fan, and in the process ensure cooling at the same time.

In many cases, however, it is more advantageous when both the fuel-conducting region and the oxidizing agent-conducting region of the fuel cell stack are sealed off with respect to one another and the surrounding area.

For such sealing, what is conventional are, for example, separately manufactured seals inserted between the bipolar plate and the membrane-electrode unit, or, for example, dispensing/spraying sealing material on respective components of the fuel cells (e.g. bipolar plate, membrane-electrode unit) during an installation process, or prefabrication of components of the fuel cells with seals already molded thereon.

In some embodiments, the fuel cells of the fuel cell arrangement are designed as suitable for operation with hydrogen as fuel, e.g. with an electrolyte membrane in the form of a proton conducting membrane.

As an alternative, however, it is also possible to consider, for example, a design of the fuel cell arrangement for operation with another fuel, such as an organic compound (e.g. methane or methanol) or e.g. natural gas.

In one embodiment, the fuel cell arrangement is designed as suitable for operation with air as oxidizing agent.

In one embodiment, the bipolar half-plates are made from a metallic material. As an alternative, the bipolar half-plates may in particular be made e.g. from a carbon material or e.g. from an electrically conductive plastics material (e.g. correspondingly doped, e.g. with carbon black), or from another electrically conductive material.

According to one embodiment, the bipolar half-plates provided in the invention are respectively prefabricated separately and joined by stacking the individual components correspondingly to form a stack when the fuel cell arrangement is being produced.

According to a further aspect, the invention relates to a method for producing a fuel cell arrangement.

### BRIEF DESCRIPTION OF THE DRAWINGS

An aspect of the invention is described in more detail below on the basis of exemplary embodiments with reference to the accompanying drawings, in which, in each case schematically:

FIG. 1 shows a sectional view through a fuel cell according to an exemplary embodiment of the prior art,

FIG. 2 shows a clamping means based on toothed belts or V-belts,

FIG. 3 shows a first embodiment of a belt receptacle which, on the side of the stack, abuts the end plates,

FIG. 4 shows a second embodiment of a belt receptacle which, on the side of the stack, abuts the end plates, and

FIG. 5 shows the embodiment of FIG. 3 for the purpose of illustrating the geometry.

### DETAILED DESCRIPTION OF THE PREFERRED EMBODIMENTS

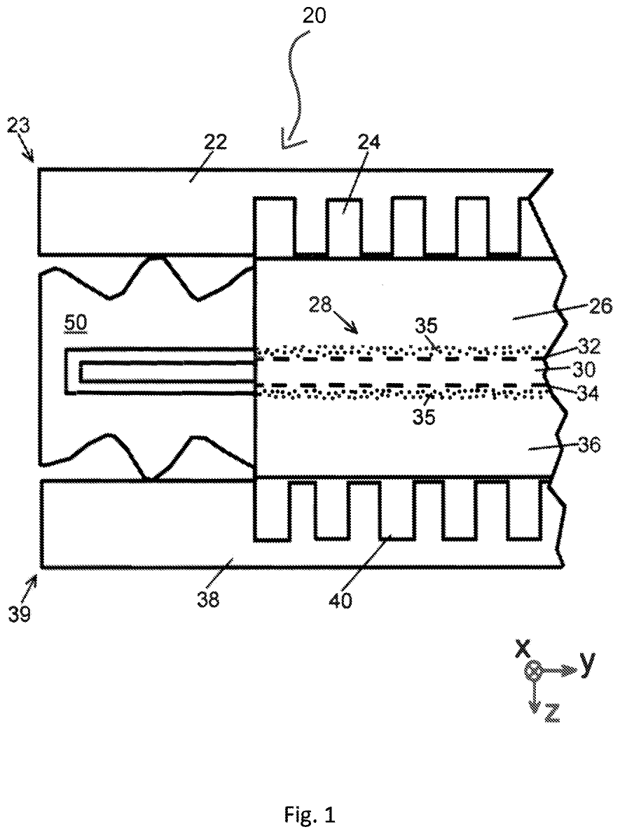

FIG. 1 shows a fuel cell 20 with a conventional structure, by means of which fuel cell the chemical reaction energy of a supplied fuel (e.g. hydrogen) and a supplied oxidizing agent (e.g. air) can be converted into electrical energy.

The fuel cell 20 has a plate-shaped form and extends in a plate plane of this shape in a first transverse direction x and a second transverse direction y (e.g. with a rectangular contour), orthogonal to the first.

The direction orthogonal to the plate plane spanned by the transverse directions x, y is referred to as stacking direction z, since, in practice, usually a multiplicity of such fuel cells 20 stacked in the stacking direction z are the basis for forming a fuel cell arrangement (“fuel cell stack”). There are end plates at the two ends in the stacking direction z. The end plates are used for stability of the stack and are generally mechanically more stable than the bipolar plates in the center of the stack. The end plates can thus exert a pressure on the stack or fuel cell stack.

The end plates can consist of the same material as the bipolar plates, or else can consist of another material.

Each fuel cell 20 is composed of a plurality of components that have a plate-shaped form and are stacked in the stacking direction z, with plate-shaped end plates at the respective ends of the stack.

In the first instance, this involves an anode-side bipolar half-plate 22, on the inner side (i.e. the side facing toward the inside of the fuel cell 20) of which a channel structure 24 for conducting the fuel, also referred to below as fuel channel structure 24, is formed.

Electric current generated during operation of the fuel cell 20 is discharged via the bipolar half-plate 22, which is produced from electrically conductive material (e.g. metal).

An electrically conductive gas diffusion layer 26 (e.g. carbon nonwoven), which is permeable to the fuel and via which the fuel reaches a membrane-electrode unit 28 adjoining it in the stacking direction z during operation of the fuel cell 20, is provided on the inner side of the bipolar half-plate 22 and thus adjoins the fuel channel structure 24.

The membrane-electrode unit 28 comprises an electrically non-conductive electrolyte membrane 30 (which conducts protons in the case of hydrogen as fuel) and electrically conductive electrode layers 32 and 34 (e.g. of metal) that are arranged on either side of said electrolyte membrane as viewed in the stacking direction z and are permeated with a catalyst 35 (e.g. platinum or palladium). In this respect, the electrode layer 32 forms the anode and the electrode layer 34 forms the cathode for an electrochemical reaction of the fuel with the oxidizing agent.

During operation of the fuel cell 20, the fuel (e.g. hydrogen) is guided up to the electrode layer 32 (anode) from the fuel channel structure 24 via the anode-side gas diffusion layer 26, and the oxidizing agent (air) is guided up to the electrode layer 34 (cathode) via a cathode-side gas diffusion layer 36 adjoining the electrode layer 34.

Adjoining this electrically conductive gas diffusion layer 36, which is permeable to the oxidizing agent, in the stacking direction z there is provided an electrically conductive, cathode-side bipolar half-plate 38, on the inner side of which a channel structure 40 for conducting the oxidizing agent, also referred to below as oxidizing agent channel structure 40, is formed.

The product of the electrochemical reaction, for example water, can be discharged via the fuel cell region that conducts the oxidizing agent (e.g. air), which fuel cell region here includes e.g. the oxidizing agent channel structure 40 of the bipolar half-plate 38. During operation of the fuel cell 20, on the cathode side the bipolar half-plate 38 serves moreover to discharge the electrical current generated by the fuel cell 20.

In the fuel cells 20, the fuel-conducting region, i.e. fuel channel structure 24, gas diffusion layer 26 and electrode layer 32 (anode), and the oxidizing agent-conducting region, i.e. oxidizing agent channel structure 40, gas diffusion layer 36 and electrode layer 34 (cathode), must be sealed off with respect to one another in order to prevent the exchange of gas between these regions, which is detrimental to the power efficiency.

For that purpose, in its lateral edge region, the fuel cell 20 has a seal 50, which bears against the bipolar half-plate 22, the bipolar half-plate 38 and the membrane-electrode unit 28, in order to provide sealing between the bipolar half-plate 22 and the membrane-electrode unit 28 and between the membrane-electrode unit 28 and the bipolar half-plate 38. In the lateral direction (transverse direction y in FIG. 1), the seal 50 terminates flush with lateral edges 23, 39 of the bipolar half-plates 22, 38.

The aim of an aspect of the present invention, in the case of a fuel cell like that depicted in FIG. 1, or in the case of a fuel cell arrangement formed from fuel cells of this type, is to present a novel way which makes it possible to realize seals for the desired conduction of fuel and/or oxidizing agent and/or cooling medium, which is possibly provided in a space between two adjacent fuel cells.

Fuel cell stacks are typically mechanically clamped by means of clamping bolts or screws, and possibly spring elements. In addition, there are solutions which guide a usually metallic band around the stack, the band then being secured to 1 or 2 securing points on the end plates of the stack and pretensioned.

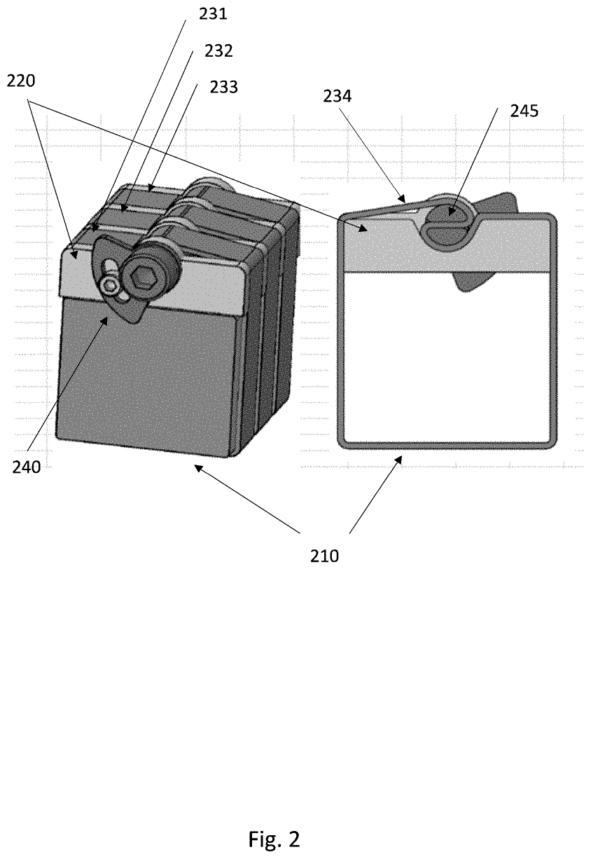

Another solution is depicted in FIG. 2, where clamping means based on toothed belts or V-belts are based on multiple belts together with multiple clamping units. The fuel cell stack 210 is clamped by means of belts 231, 232, 233, 234. The belts run over an end plate 220, where a clamping regulator 240, 245 enables regulation of the clamping.

However, the multiplicity of clamping points, and the multiplicity of screws and other movable components required to set the preload force, can be disadvantageous. In addition, from time to time spring elements or clamping bands are required to adapt or compensate pressure.

It is advantageous for mass production and for incorporation into a fast and productive manufacturing installation to be able to apply correspondingly fast clamping processes. Similarly, the number of individual parts required for manufacture and for clamping should be kept as low as possible.

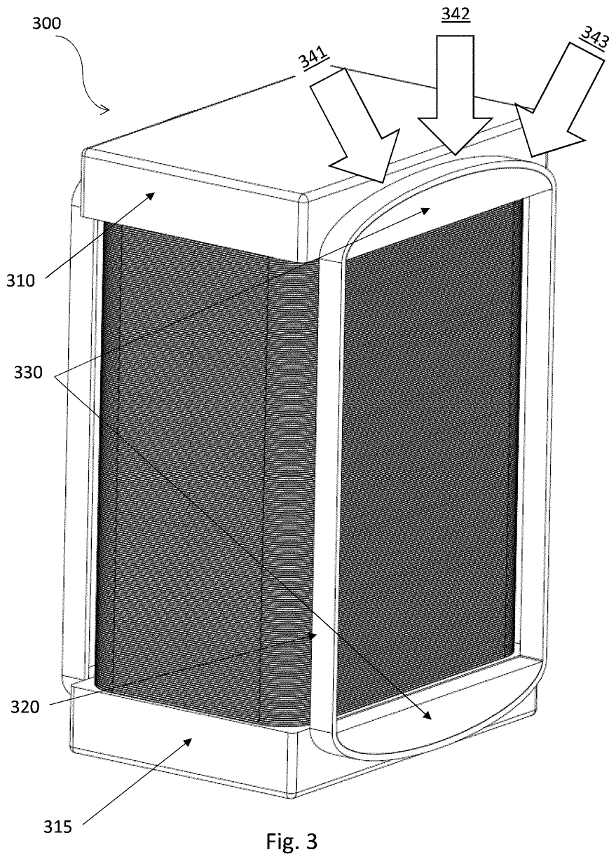

FIG. 3 depicts a first embodiment of a belt receptacle 330 which, on the side of the stack 300, abuts the end plates 310, 315. A belt and its belt receptacles can be seen; a total of two belts clamp the stack. The belt receptacle can be installed on the end plates fixedly or else variably in terms of height. Various setting possibilities can be applied. A belt 320 as clamping element can be mounted via the belt receptacle at the end of manufacture of the stack. Depending on the installation concept, the belt is installed after initial pretensioning of the stack.

If appropriate, the belts are then set to a desired pretension and the stack is thus fully clamped.

The belt 320 exerts pressure on the belt receptacle 330. Various actions of pressure are illustrated in the form of arrows 341, 342, 343. Depending on the mechanical requirements of and space needed for the stack and end plate geometry, the belt receptacle can be adapted. This also makes it possible to adapt the action of pressure. In various embodiments of the invention, the belt receptacles can have a circular shape, or an ellipsoidal shape, or a semicircular shape. The two belt receptacles from the embodiment of FIG. 3 can both have the same shape, or different shapes.

The end plates must be configured for the pressure that is exerted. They may be formed from or consist of e.g. metal, e.g. steel, these being electrically conductive, and thus there must be an electrical insulation layer between the end plates and the active cells. The end plates can also consist of an electrically non-conductive material, such as polymer compounds. However, the required mechanical properties must be ensured.

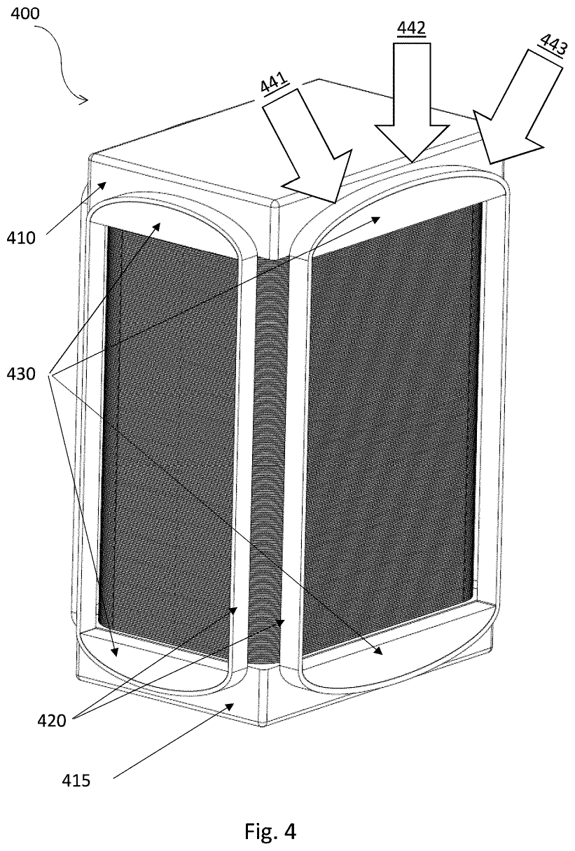

FIG. 4 shows a second embodiment of a belt receptacle 430 which, on the side of the stack 400, abuts the end plates 410, 415. Two of four belts, or two belt pairs, which clamp the stack can be seen. The belt receptacles can be installed on the end plates fixedly or adaptably, with a setting possibility. A belt 420 as clamping element can be mounted via the belt receptacle at the end of manufacture of the stack. Depending on the installation concept, the belt is installed after initial pretensioning of the stack. As in FIG. 3, if appropriate, the belts are then set to a desired pretension and the stack is thus fully clamped.

Depending on the structure and requirement, the two belt pairs can have different lengths or geometries, that is to say the two belts have lateral properties and properties orthogonally in relation thereto that are different. The belt pairs can have different mechanical properties. For instance, they can have different lengths, different thicknesses or widths or strengths, with different expansion rates, etc. The receptacles can also have different configurations. Individual belts can have different mechanical properties and/or have different lengths or geometries. There can also be differences between belt pairs or individual belts in terms of the clamping process. Therefore, for example, a first belt pair is pushed on, a second belt pair is pushed on, possibly set with different pretensions on the clamping elements, and the fuel cell stack is thus constructed.

The belt 420 exerts pressure on the belt receptacle 430. Various actions of pressure are illustrated in the form of arrows 441, 442, 443. Depending on the mechanical requirements of and space needed for the stack and end plate geometry, the belt receptacle can be adapted, and therefore so can the action of pressure. In various embodiments of the invention, the belt receptacles can have a circular shape, or an ellipsoidal shape, or a semicircular shape. The eight belt receptacles from the embodiment of FIG. 4 can all have the same shape, or different shapes.

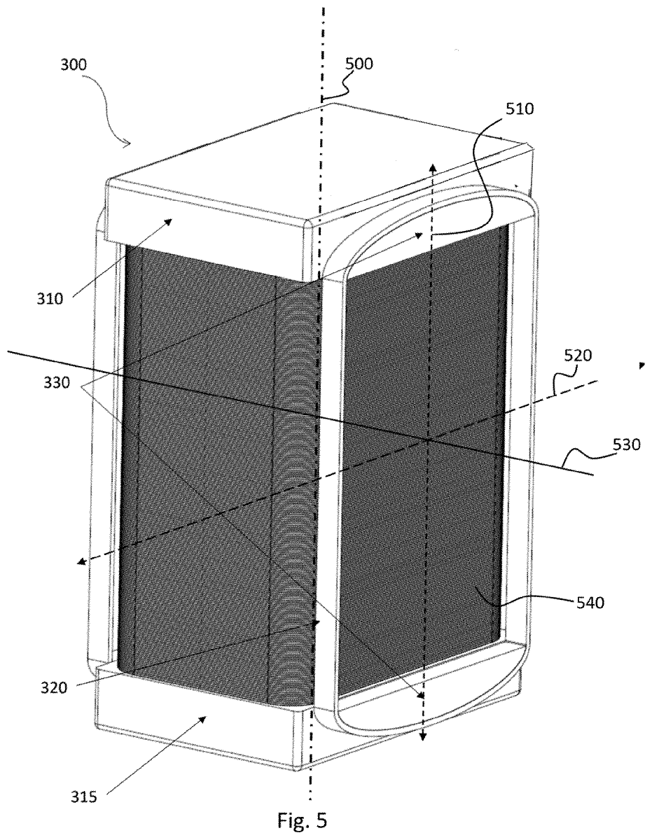

FIG. 5 shows the embodiment of FIG. 3 once again for the purpose of illustrating the geometry. A longitudinal axis 500 extends through the fuel cell stack 300 in the middle in the stacking direction. The clamping belts 320 span a plane, illustrated by the axes 510 and 520. The perpendicular bisector 530 of the clamping belt 320 is perpendicular to the plane spanned by the axes 510 and 520 and to the longitudinal axis 500 of the stack. The plane spanned by the axes 510 and 520 (and by the clamping belt) runs parallel to the side surface 540 of the stack.

1. A fuel cell stack, having fuel cells which are stacked in a stacking direction and each of which has a plate-shaped form and extends in a first transverse direction and a second transverse direction, orthogonal to the first, as viewed orthogonally in relation to the stacking direction, wherein, in the stacking direction, the fuel cells have a stack of the following:
an anode-side bipolar half-plate with a fuel channel structure for conducting a fuel,
an anode-side gas diffusion layer,
a membrane-electrode unit, having an electrolyte membrane and electrode layers which are arranged on either side of said electrolyte membrane in the stacking direction and form an anode and a cathode for an electrochemical reaction of the fuel with an oxidizing agent,
a cathode-side gas diffusion layer,
a cathode-side bipolar half-plate with an oxidizing agent channel structure for conducting the oxidizing agent,
and end plates at either end of the stack in the stacking direction z, wherein, on the side of the stack, belt receptacles are mounted on the end plates, and belts are mounted over the belt receptacles such that they clamp the stack.

2. The fuel cell stack as claimed in claim 1, wherein at least one belt receptacle is displaceable in the stacking direction.

3. The fuel cell stack as claimed in claim 1, wherein the belt receptacles have a circular shape, or an ellipsoidal shape, or a semicircular shape.

4. The fuel cell stack as claimed in claim 1, wherein the belt is guided over a belt receptacle on a first end plate and over a belt receptacle on a second end plate such that the belt borders most, in particular more than 50%, more than 60%, or more than 70%, of the lateral surface of the fuel cell stack in a lateral plan view of a side surface of the fuel cell stack.

5. The fuel cell stack as claimed in claim 1, wherein the belt receptacles all have the same shape.

6. The fuel cell stack as claimed in claim 1, wherein the belt receptacles have different shapes.

7. The fuel cell stack as claimed in claim 1, wherein the end plates consist of the same material as the bipolar plates.

8. The fuel cell stack as claimed in claim 1, wherein the end plates consist of electrically conductive material, and, in the case of each fuel cell, the intermediate region of the anode-side bipolar half-plate and/or the intermediate region of the cathode-side bipolar half-plate has a projection protruding in the stacking direction.

9. The fuel cell stack as claimed in claim 1, wherein the end plates consist of an electrically non-conductive material.

10. The fuel cell stack as claimed in claim 1, wherein multiple belt pairs are mounted and the belts in pairs have different properties.

11. A method for producing a fuel cell stack as claimed in claim 1, comprising:
forming a fuel cell arrangement by stacking fuel cells in a stacking direction, each of which has a plate-shaped form and extends in a first transverse direction and a second transverse direction, orthogonal to the first, as viewed orthogonally in relation to the stacking direction, wherein, in the stacking direction, the fuel cells have a stack of the following: an anode-side bipolar half-plate with a fuel channel structure for conducting a fuel; an anode-side gas diffusion layer; a membrane-electrode unit, having an electrolyte membrane and electrode layers which are arranged on either side of said electrolyte membrane in the stacking direction and form an anode and a cathode for an electrochemical reaction of the fuel with an oxidizing agent; a cathode-side gas diffusion layer; a cathode-side bipolar half-plate with an oxidizing agent channel structure for conducting the oxidizing agent; and end plates at either end of the stack in the stacking direction z, and
on the side of the stack, mounting belt receptacles on the end plates,
wherein belts are mounted over the belt receptacles such that they clamp the stack.

12. The method for producing a fuel cell stack as claimed in claim 11, wherein the one or more belts are installed after initial pretensioning of the stack.
